(19) United States
(12) Patent Application Publication
(10) Pub. No.: US 2012/0109663 A1
(43) Pub. Date: May 3, 2012

(54) Advanced Metering Infrastructure Event Filtering

(75) Inventors: Gregory Ray Floyd, McDonough, GA (US); Eric A. Morris, Acworth, GA (US)

(73) Assignee: SOUTHERN COMPANY SERVICES, INC., Atlanta, GA (US)

(21) Appl. No.: 12/916,083

(22) Filed: Oct. 29, 2010

(51) Int. Cl. G06Q 10/00; G06F 17/30

(52) U.S. Cl. 705/1.1; 707/769; 707/E17.005; 707/E17.014

(57) ABSTRACT

Disclosed are various embodiments for validating and filtering events related to an Advanced Metering Infrastructure (AMI) deployment. Events received from a vendor supplied AMI head-end can be validated by an AMI event filtering application, which can then store the validated event in a data store. The AMI event filtering application can also generate and publish destination filtered and/or composite events based at least upon destination filters and/or composite events defined in the data store. Subscribing systems can receive the destination filtered and/or composite events.

### BACKGROUND

Advanced Metering Infrastructure (AMI) deployments are increasing in prevalence because the AMI deployments can reduce labor costs as well as increase billing efficiency relative to other utility metering deployments. As more AMI metering devices are employed, the amount of data that must be managed increases accordingly. A metering infrastructure vendor can supply a head-end that facilitates communication with communications towers as well as metering devices in such a deployment. However, the vendor supplied head-end often lacks the data management and filtering capabilities that may be desired by a utility operator.

### BRIEF DESCRIPTION OF THE DRAWINGS

Many aspects of the present disclosure can be better understood with reference to the following drawings. The components in the drawings are not necessarily to scale, emphasis instead being placed upon clearly illustrating the principles of the disclosure. Moreover, in the drawings, like reference numerals designate corresponding parts throughout the several views.

FIG. 1 is a drawing of an AMI utility metering environment according to various embodiments of the present disclosure.

FIG. 2 is a drawing of illustrating the flow of data between components in the AMI utility metering environment according to various embodiments of the disclosure.

FIG. 3 is a flowchart illustrating one example of functionality implemented as portions of the AMI event filtering application executed in a computing device in the AMI utility metering environment of FIG. 1 according to various embodiments of the present disclosure.

FIG. 4 is a schematic block diagram that provides one example of a computing device in which an AMI database can be implemented in the AMI utility metering environment of FIG. 1 according to various embodiments of the present disclosure.

### DETAILED DESCRIPTION

Embodiments of the present disclosure facilitate distribution of events generated by an AMI head-end. Embodiments of the disclosure provide the ability to configure various characteristics of delivery of events to subscribing systems as will be described herein. In some embodiments, events generated by an AMI head-end can be filtered according priority, type, and other characteristics, and can then be published in a standardized format on an enterprise system bus, allowing subscribing systems to receive the events that are of interest to the subscribing system. Reference will now be made to one example of an AMI utility metering environment according to an embodiment of the disclosure, which illustrates one example of such a system.

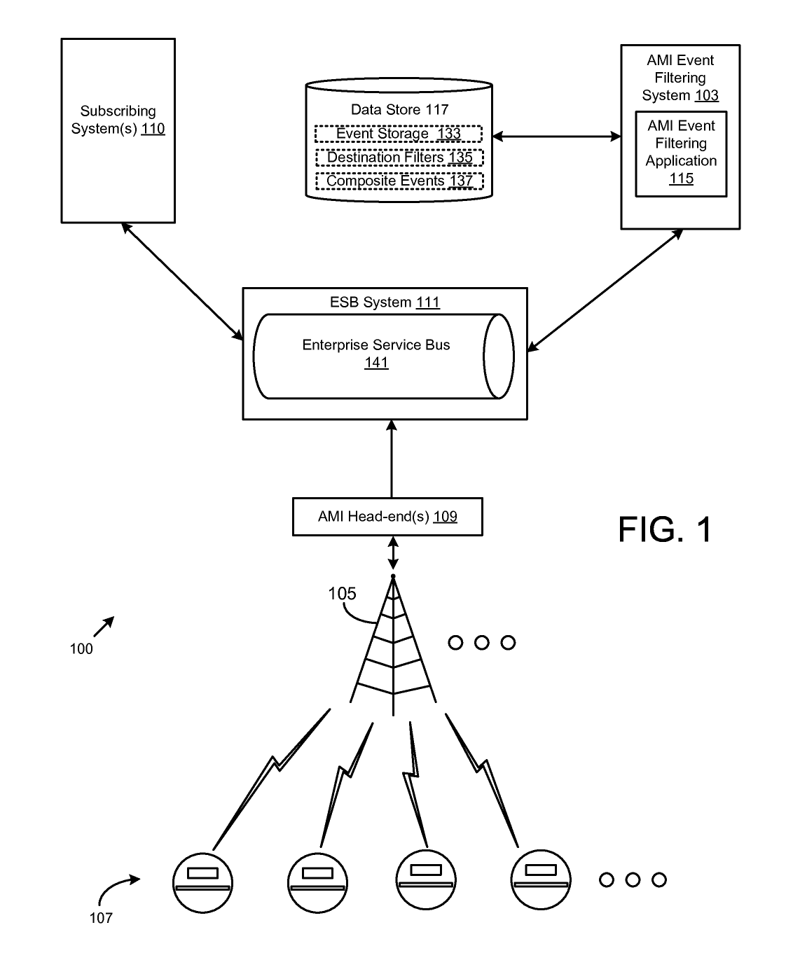

With reference to FIG. 1, shown is an AMI utility metering environment 100 according to various embodiments. The AMI utility metering environment 100 includes an AMI event filtering system 103 in communication with a metering infrastructure. The metering infrastructure can, in one non-limiting embodiment, include one or more communications towers 105 or tower gateway base stations (TGB) that can receive utility usage information from a fleet of utility metering devices 107 that are deployed at various customer premises. Additionally, a metering vendor facilitating deployment of an AMI utility metering environment often provides one or more AMI head-end 109 which interfaces with the various communications towers 105 in a deployment to collect usage data, alarm messages, and other statistics, values and metrics that can originate from the metering devices 107 and/or the communications towers 105. Also shown in the AMI utility metering environment 100 of FIG. 1 is an ESB system 111 that is in communication with the head-end 109 as well as the AMI event filtering system 103. The AMI utility metering environment 100 can also include a data store 117 which can act as a repository of events received from the AMI head-end 109. Subscribing systems 110 in communication with the ESB system 111 can receive events generated by the AMI event filtering system 103 that are published by the AMI event filtering system 103 on an enterprise service bus.

It should be appreciated that a utility metering device can also include, in some embodiments, any device, such as an impedance fault detection device, that can report data to an AMI head-end 109. A utility metering device that can consume or provide power in a utility metering environment. In some embodiments, communication between metering devices and the AMI head-end 109 can be accomplished with utility metering devices that are configured to transmit data via a two way power line carrier (PLC) system infrastructure. Accordingly, in such an embodiment, utility metering devices can be in communication with a distribution substation or other infrastructure, which can receive data via a PLC protocol and forward any received data to the AMI head-end 109. Therefore, embodiments of the present disclosure can be implemented without a communications tower 105, as metering devices can communicate with the AMI head-end 109 in various ways that should be appreciated by a person of ordinary skill in the art.

The head-end 109 can transmit events that relate to occurrences within or related to an AMI deployment to the ESB system 111, which can route the events to the AMI event filtering system 103. The AMI event filtering system 103 can facilitate storage of the event in the data store 117. It should be appreciated that in some embodiments, the ESB system 111 can interact directly with the data store 117 to facilitate storage of the events therein. Accordingly, the AMI event filtering system 103 can process the events received from the head-end 109 and generate validated events of varying types that can be passed on to subscribing systems 110 based on one or more subscription definitions corresponding to the subscribing system 110. A subscribing system 110 can include any application or computing device that can be configured to receive validated events corresponding to occurrences within an AMI deployment. As one example, a subscribing system 110 can include an AMI operations system that is employed to track outages in a deployment. Accordingly, the AMI event filtering system 103 can generate outage events based upon events received from the head-end 109, to which the AMI operations system can subscribe. As another example, a subscribing system 110 can include an AMI maintenance system that is employed to track work orders related to utility metering devices in the AMI deployment. Accordingly, the AMI maintenance system can subscribe to events related to metering devices associated with maintenance work orders.

The AMI event filtering system 103, ESB system 111, data store 117, subscribing system 110, and AMI head-end 109 may comprise, for example, a computing device, a server computer or any other system providing computing capability or resources. Alternatively, a plurality of computing devices may be employed that are arranged, for example, in one or more server banks or computer banks or other arrangements. For example, a plurality of computing devices together may comprise, for example, a cloud computing resource, a grid computing resource, and/or any other distributed computing arrangement. Such computing devices may be located in a single installation or may be distributed among many different geographical locations. Additionally, some components executed on a computing device can be executed in one installation, while other components can be executed in another installation. For purposes of convenience, the computing device is referred to herein in the singular. Even though the computing device is referred to in the singular, it is understood that a plurality of computing devices may be employed in the various arrangements as described above.

The communications towers 105 can be configured to receive usage data, alarm messages, or other information from utility metering devices 107 deployed in an AMI deployment. As should be appreciated, utility metering devices 107 can be configured to provide one-way communication or two-way communication to report usage data associated with a meter, status information, alarm messages, and other administrative data. Additionally, in two-way systems, administrative information or various commands that can cause a utility metering device 107 to take some course of action can be transmitted to the utility metering devices 107 via a communications tower 105. As one example, the AMI event filtering system 103 and/or AMI head-end 109 can transmit a command via the communications towers 105 causing a utility metering device 107 to report usage data. It should further be appreciated that a utility metering device 107 can also interact with any system (e.g., a computing device, a metering collection device, a vehicle mounted metering collection device, a mobile collector, a local area fixed collector, etc.) complying with a communications protocol specified by the metering infrastructure, regardless of whether such a system is transmitting data and/or messages via the depicted communications towers 105.

The utility metering devices 107 can, in some embodiments, transmit and/or receive data wirelessly to and from the AMI head-end 109 via one or more communications towers 105. In one embodiment, metering devices 107 can communicate with the meter AMI event filtering system 103 via wireless messages in a proprietary or non-proprietary format in licensed or unlicensed wireless spectrum. In other embodiments, the AMI head-end 109 can communicate with metering devices via standardized cellular communications technology such as, but not limited to, GPRS, CDMA, and other technologies as can be appreciated.

Various applications and/or other functionality may be executed in the AMI event filtering system 103 according to various embodiments. In the depicted non-limiting embodiment, the meter AMI event filtering system 103 can execute an AMI event filtering application 115 that can include various modules that facilitate the functionality described herein. It should be appreciated that the depicted arrangement of an AMI event filtering application 115 executing various modules is but one non-limiting example of an arrangement of an embodiment of the disclosure given for ease of depiction as well as discussion herein. It should also be appreciated that embodiments of the disclosure can be implemented in various ways. As one example, the logic within the AMI event filtering application 115 can be embodied in one or more stored procedures that defines various rules and queries to be performed in a SQL based database system or other database architecture. In another example, the logic within the AMI event filtering application 115 can be embodied in an application executed in a computing device in communication with a database as is depicted in the example of FIG. 1. In yet other embodiments, the logic of the AMI event filtering application 115 can be implemented as logic within the framework of an enterprise service bus, which can facilitate the publishing of events to subscribing systems 110. Other variations should be appreciated by a person of ordinary skill in the art.

As shown in FIG. 1, the AMI event filtering system 103 is in communication with a data store 117, which can comprise a SQL based database or other database system. The data store 117 can store data in a relational table structure or other storage formats as can be appreciated. The data stored in the data store 117 includes, for example, event storage 133, a destination filter table 135, a composite event table 137, and potentially other data. The event storage 133 can include validated events generated by the AMI event filtering application 115 that correspond to events generated by the AMI head-end 109. Validated events can be events that are validated by the AMI event filtering application 115 as will be described in further detail herein. A validated event can include an identifier that corresponds to a communications tower and/or a utility metering device with which the event corresponds. A validated event can also include an event type (e.g., outage alarm, tamper alarm, restore alarm, etc.), a time stamp and other event information as can be appreciated.

The destination filter table 135 can include a subscription definition for real time events generated by the AMI event filtering application 115. A real time event can include a validated event that corresponds to an event from the AMI head-end 109 for which a subscribing system 110 is subscribed. In other words, upon validating an event from the AMI head-end, the AMI event filtering application 115 can store the event in the event storage 133 and consult the destination filter table 135 to determine which subscribing systems 110 are designated to receive the validated event in real time. Accordingly, the AMI event filtering application 115 can then route the validated event to the subscribing systems 110 as designated in the destination filter table 135.

The composite event table 137 can define composite events that the AMI event filtering application 115 can generate and route to subscribing systems 110. Composite events generated by the AMI event filtering application 115 are those that are based on multiple events received from the AMI head-end 109 over a period of time. A composite event can also be based on an event received from the AMI head-end 109 and other data accessible to the AMI event filtering application 115 regarding the AMI deployment. A composite event can also include the non-reporting of an event from the AMI head-end 109 based on other data available to the AMI event filtering application 115. As one example of such a non-reporting of an event, the AMI event filtering application 115 can determine that an outage event reported by the AMI head-end 109 in conjunction with data that a particular metering device is under maintenance means that the outage event should not be reported to subscribing systems 110 as a meter outage. As another example, an outage event reported by the AMI head-end 109 associated with a particular identifier corresponding to a metering device coupled with a subsequent tamper event for the same metering device within a threshold period of time may mean that the outage event should not be reported, as these occurrences can mean that the metering device is under maintenance. As another example, any events that are received within a certain threshold time period of a brown-out condition event may mean that these events should not be reported until the brown-out condition is corrected.

Other structures of the data store 117 may also be employed that are consistent with this disclosure. As one example, validated events as well as destination filters and composite event definitions can be stored in various data store table structures that vary from the depicted example. Additionally, the data store 117 can be implemented in the same or a separate installation from a computing device in which the AMI event filtering application 115 is executed. The AMI event filtering system 103 and/or data store 117 can also be implemented in a bank of server computing devices for scalability and data redundancy purposes. The depicted AMI event filtering system 103 and data store 117 shown in FIG. 1 is given for ease of depiction and discussion of the various embodiments of the present disclosure and is but one example.

The AMI head-end 109 can be provided by vendors of equipment in an AMI deployment to facilitate interactions with communications towers 105 and/or utility metering devices 107. Accordingly, the AMI head-end 109 monitor the status of an AMI deployment as well as receive usage data and other information from utility metering devices 107 and/or communications towers 105. In response to data received from an AMI deployment (or the lack thereof), the AMI head-end 109 can generate events that correspond to occurrences within the AMI deployment. Accordingly, in one embodiment, the AMI head-end 109 can receive messages and/or alarms from communications towers 105 that correspond to a status of the communications towers 105 as well as status or usage data from the metering devices 107 in a deployment. As some examples, the AMI head-end 109 can generate events that correspond to an outage, a tamper alarm associated with a tower and/or metering device, and other events that may occur in an AMI deployment as can be appreciated.

In many AMI deployments, the AMI head-end 109 does not provide sufficient event monitoring or statistical information from which events, alarms or other alerts desired by a utility can be generated. Additionally, the AMI head-end often does not maintain a complete archive of events generated by the AMI head-end 109 in response to occurrences within a deployment.

The ESB system 111 can execute an enterprise service bus 141 configured to support messaging between the various components shown in the environment of FIG. 1. In other words, the enterprise service bus 141 can act as an intermediary between the AMI head-end 109, the AMI event filtering system 103 as well as subscribing systems 110 to facilitate the transmission of data there between. The enterprise service bus may also be referred to as a “message broker” or an intermediary program that transforms messages from a one system to another, thereby allowing the systems to send data back and forth to one other. For example, the AMI head-end 109 may transmit events in an XML format over Hypertext Transfer Protocol (HTTP), which can then be transformed by the ESB into plain text for the AMI event filtering system 103. In other words, the ESB provides functionality to support interoperable machine to machine interaction over a network in potentially varying message formats as well as varying protocols. The specific functionality provided by an ESB should be appreciated to those of ordinary skill in the art, and is not discussed in detail herein.

Now that a general description of the various components in the AMI utility metering environment 100 has been provided, a description of the operation of the various components is provided. As described above, the AMI head-end 109 generates events that correspond to occurrences within an AMI deployment. The AMI head-end 109 can transmit these events to the ESB, which can provide the event to the AMI event filtering application logic. The AMI event filtering application 115 can then validate the event and store it as a validated event in the event storage 133. In one embodiment, the AMI event filtering system 103 can validate an event by determining whether the event is a duplicate event that has already been received, validated and stored in the data store 117 by the AMI event filtering application 115. As one example, the AMI event filtering application 115 can check whether the AMI head-end 109 has detected that the event is a duplicate event and set a flag to this effect.

Validation of the event by the AMI event filtering application 115 can also include verifying that an identifier associated with the event corresponding to a metering identifier and/or a communications tower corresponds to an asset that is within a particular AMI deployment associated with a particular utility operator. As one non-limiting example, the AMI event filtering application 115 can verify that an identifier (e.g., a serial number of a metering device, etc.) associated with the event corresponds to a known list of identifiers operated by a particular utility operator. Accordingly, if the event is associated with an unknown identifier, the AMI event filtering application 115 can discard the event. Validation of the event can also include retrieving an asset identifier or other internal identifier associated with the metering device and/or communications tower, which can be stored with the validated event in the event storage 133.

Validation of the event can also include determining whether the event received from the AMI head-end 109 corresponds to an event that is of interest. As one non-limiting example, the AMI event filtering application 115 can determine whether an event from the AMI head-end 109 is extraneous or is of no interest to a utility operator, and discard events without storing a corresponding validated event in the event storage 133.

Validation of the event can also include transforming the event into a standardized message format prior to storing the validated event in the event storage 133. The event received from the AMI head-end 109 can be formatted in a vendor specific schema that can vary from vendor to vendor. Accordingly, the AMI event filtering application 115 can perform an XML transformation of the event into a message format that is standardized for all validated events prior to storage in the event storage 133. Upon validation of the event and storage as a validated event in the event storage 133, the AMI event filtering application 115 can then publish the validated event on the ESB 141. In this way, the AMI event filtering application 115 can provide the validated event as a real time event to subscribing systems 110 via the ESB 141. The ESB 141 can distribute an event published on the ESB 141 to subscribing systems 110 configured to receive events in this way.

Some subscribing systems 110 may not be configured to receive events that are published on the ESB 141 in real time. Accordingly, the AMI event filtering application 115 can publish validated events from the data store 117 to certain subscribing systems 110 for which a subscription has been defined in the destination filter table 137. A destination filter defined in the destination filter table 135 can define one or more subscribing systems 110 to which a validated event should be published based on varying filtering criteria. As one example, a destination filter can specify that a particular subscribing system 110 is configured to only receive a certain type of event. As another non-limiting example, a destination filter can specify that a particular subscribing system 110 should only receive validated events during a particular time window, at a certain frequency, that are associated with a particular subset of metering device identifiers, that are events generated within a certain time window, and that can be based on other examples of filtering criteria as can be appreciated. Therefore, the AMI event filtering application 115 can publish these validated events with a destination designation associated with the subscribing system 110 according to various criteria specified by the destination filter table 135.

Another example of a destination filter defined for a subscribing system 110 can include a filter that specifies that a particular subscribing system 110 should not receive events that are associated with a malfunctioning metering device. Accordingly, the AMI event filtering application 115 can detect a malfunctioning metering device based on one or more events received from the metering device over a given period of time. The AMI event filtering application 115 can then maintain a list of malfunctioning metering devices and obey such a destination filter specified in the data store 117. As one example, if a metering device is repeatedly reporting events that indicate meter failure, the AMI event filtering application 115 can validate and store these events in the event storage 133, but refrain from publishing events from such a metering device to a subscribing system 110 that is configured to not receive events from malfunctioning devices.

The AMI event filtering application can generate composite events based on one or more composite event definition stored in the data store 117 in the composite events table 137. As noted above, a composite event can be an event that is based upon an event received from the AMI head-end 109 in conjunction with another piece of data accessible to the AMI event filtering application 115. A composite event can also include detection of a “non-event,” where the AMI event filtering application 115 waits a period of time before publishing an event on the ESB so that the AMI event filtering application 115 can verify that an event is genuine. Accordingly, the AMI event filtering application 115 can generated composite events according to definitions in the composite events table 137, and publish these events with a destination designation associated with the subscribing systems 110 on the ESB.

The AMI event filtering application 115 can also provide a web based configuration user interface that allows the subscriptions of subscribing systems 110 to be configured. For example, the configuration user interface can allow a user to modify the destination filters as well as composite event filters associated with a particular subscribing system 110, thereby modifying the way in which the AMI event filtering application 115 detects events and publishes events on the ESB.

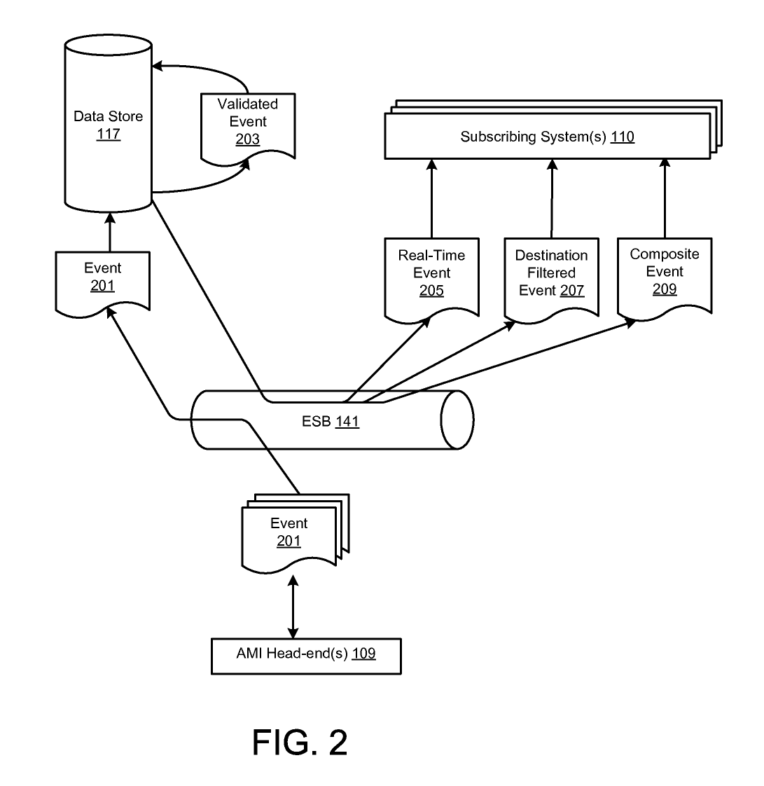

Reference is now made to FIG. 2, which shows one example of the flow of data between the various components in the AMI utility metering environment 100 of FIG. 1. As described above, an event 201 is generated by the AMI head-end 109, which can transmit the event 201 to the enterprise service bus (ESB) 141. In other words, the AMI head-end 109 can publish the event 201 on or via the enterprise service bus 141 with a destination designation associated with the AMI event filtering system 103. Accordingly, the AMI event filtering system 103 and/or data store 117 can receive the event 201 from the enterprise service bus 141 and the AMI event filtering application 115 logic, whether embodied in an executable program or a stored procedure in a database architecture, can validate the event 201 and generate a validated event 203 to be stored within a data store 117. Events 201 that are not validated may be discarded by the AMI event filtering application 115.

Accordingly, the validated event 203 can be published on the enterprise service bus 141 so that subscribing systems 110 configured to receive the validated events 203 in real-time can receive the validated event in a standardized message format. In other words, the AMI event filtering application 115 can publish a real-time event 205 on the enterprise service bus 141, which can be received by the appropriate subscribing systems 110. In this sense, a real-time event 205 can represent a validated event 203 that is simply published on the enterprise service bus 141 so that subscribing systems 110 configured to receive unfiltered validated events 203 can do so. Additionally, the AMI event filtering application 115 can analyze the various properties of the validated event 203 and consult the destination filter table 135 to determine whether a destination filter defined in the destination filter table 135 specifies that one or more subscribing system 110 are designated to receive a validated event 203 matching one or more of the attributes of the event. As some non-limiting examples, a destination filter can designate that a particular subscribing system 110 should receive a validated event 203 that meets certain filtering criteria.

As some non-limiting examples, a destination filter can designate that a subscribing system 110 should receive events that correspond to an event type (e.g., outage alarm, tamper alarm, etc.) a particular meter identifier, a customer account that may be associated with the meter identifier, a utility operating company associated with the metering device, whether the device is undergoing maintenance, a geographic location of the device, or other properties of the validated event 203 as can be appreciated. Accordingly, the AMI event filtering application 115 can generate a destination filtered event 207 that can be published on the enterprise service bus 141 so that an appropriate subscribing system 110 can receive the destination filtered event 207.

The AMI event filtering application 115 can also analyze the characteristics of the event as well as other validated events already stored within the data store 117 to determine whether a composite event 209 should be generated. As described above, a composite event 209 can be generated by the AMI event filtering application 115 and correspond to more than one event or occurrence within the AMI deployment over a period of time. The properties of such a composite event 209 can be defined in the composite events table 137 of the data store 117. In one embodiment, a composite event 209 defined by the composite events table 137 may be based upon validated events 203 which, if generated within a certain time window, can cause a composite event 209 to be generated. In another embodiment, the composite events table 137 can define a validated event 203 that, in conjunction with other data from potentially other sources, can also cause a composite event 209 to be generated.

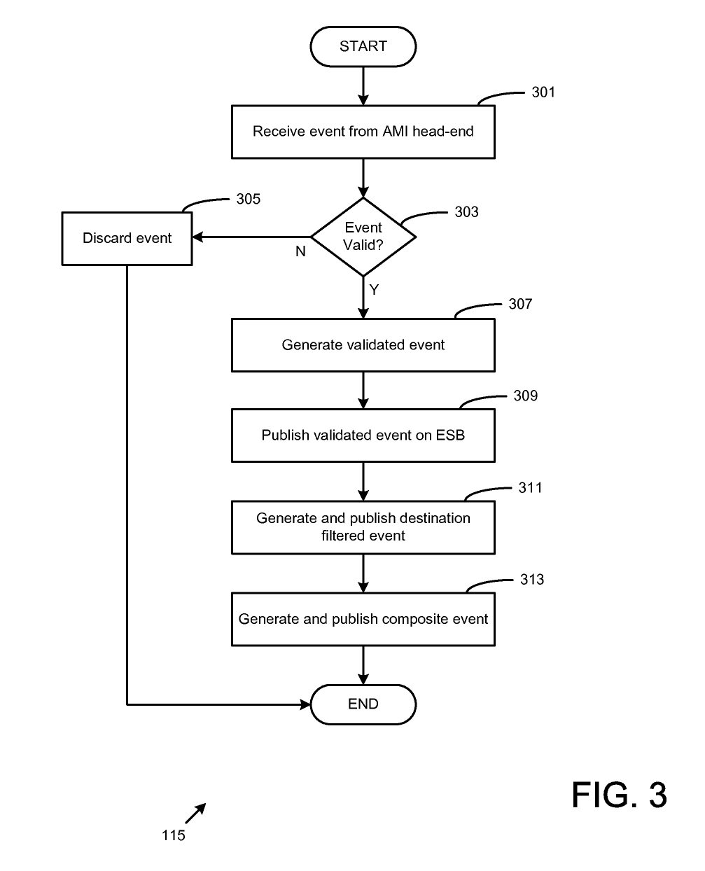

Referring next to FIG. 3, shown is a flowchart that provides one example of the operation of a portion of the AMI event filtering application 115 according to various embodiments. It is understood that the flowchart of FIG. 3 provides merely an example of the many different types of functional arrangements that may be employed to implement the operation of the portion of the AMI event filtering application 115 as described herein. As an alternative, the flowchart of FIG. 3 may be viewed as depicting an example of steps of a method implemented in the AMI event filtering system 103 (FIG. 1) according to one or more embodiments.

Beginning with box 301, an event from the AMI head-end 109 is received via the enterprise service bus 141. In box 303, the AMI event filtering application 115 validates the received event. If the event is invalid, then it is discarded in box 305. If the event is validated in box 303, the AMI event filtering application 115 can generate a validated event in box 307. In box 309, the validated event can be published on the enterprise service bus 141. After storing the validated event in the data store 117, the AMI event filtering application can generate and publish any destination filtered events corresponding to the validated event in box 311. Additionally, in box 313, the AMI event filtering application 115 can likewise generate composite events that are based on composite event definitions specified in the composite events table 137 in the data store 117.

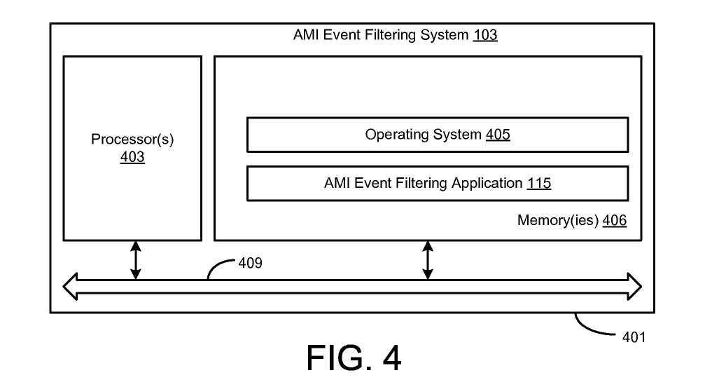

With reference to FIG. 4, shown is a schematic block diagram of the computing device 401 that may implement the AMI event filtering system 103 according to an embodiment of the present disclosure. The computing device 401 includes at least one processor circuit, for example, having a processor 403 and a memory 406, both of which are coupled to a local interface 409. To this end, the computing device 401 may comprise, for example, at least one server computer or like device. The local interface 409 may comprise, for example, a data bus with an accompanying address/control bus or other bus structure as can be appreciated.

Stored in the memory 406 are both data and several components that are executable by the processor 403. In particular, stored in the memory 406 and executable by the processor 403 are an operating system 405, the AMI event filtering application 115, and potentially other applications. As described above, in some embodiments, the AMI event filtering application 115 logic can also be implemented as a stored procedure executed in a database system as well as in an enterprise service bus.

It is understood that there may be other applications that are stored in the memory 406 and are executable by the processors 403 as can be appreciated. Where any component discussed herein is implemented in the form of software, any one of a number of programming languages may be employed such as, for example, C, C++, C#, Objective C, Java, Javascript, Perl, PHP, Visual Basic, Python, Ruby, Delphi, Flash, Standard Query Language (SQL) or any other programming or scripting languages.

A number of software components are stored in the memory 406 and are executable by the processor 403. In this respect, the term “executable” means a program file that is in a form that can ultimately be run by the processor 403. Examples of executable programs may be, for example, a compiled program that can be translated into machine code in a format that can be loaded into a random access portion of the memory 406 and run by the processor 403, source code that may be expressed in proper format such as object code that is capable of being loaded into a random access portion of the memory 406 and executed by the processor 403, or source code that may be interpreted by another executable program to generate instructions in a random access portion of the memory 406 to be executed by the processor 403, etc. An executable program may be stored in any portion or component of the memory 406 including, for example, random access memory (RAM), read-only memory (ROM), hard drive, solid-state drive, USB flash drive, memory card, optical disc such as compact disc (CD) or digital versatile disc (DVD), floppy disk, magnetic tape, or other memory components.

The memory 406 is defined herein as including both volatile and nonvolatile memory and data storage components. Volatile components are those that do not retain data values upon loss of power. Nonvolatile components are those that retain data upon a loss of power. Thus, the memory 406 may comprise, for example, random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, the RAM may comprise, for example, static random access memory (SRAM), dynamic random access memory (DRAM), or magnetic random access memory (MRAM) and other such devices. The ROM may comprise, for example, a programmable read-only memory (PROM), an erasable programmable read-only memory (EPROM), an electrically erasable programmable read-only memory (EEPROM), or other like memory device.

Also, the processor 403 may represent multiple processors 403 and the memory 406 may represent multiple memories 406 that operate in parallel processing circuits, respectively. In such a case, the local interface 409 may be an appropriate network that facilitates communication between any two of the multiple processors 403, between any processor 403 and any of the memories 406, or between any two of the memories 406, etc. The local interface 409 may comprise additional systems designed to coordinate this communication, including, for example, performing load balancing. The processor 403 may be of electrical or of some other available construction.

Although the AMI event filtering application 115 and other various systems described herein may be embodied in software or code executed by general purpose hardware as discussed above, as an alternative the same may also be embodied in dedicated hardware or a combination of software/general purpose hardware and dedicated hardware. If embodied in dedicated hardware, each can be implemented as a circuit or state machine that employs any one of or a combination of a number of technologies. These technologies may include, but are not limited to, discrete logic circuits having logic gates for implementing various logic functions upon an application of one or more data signals, application specific integrated circuits having appropriate logic gates, or other components, etc. Such technologies are generally well known by those skilled in the art and, consequently, are not described in detail herein.

The flowchart of FIG. 3 shows the functionality and operation of an implementation of portions of the AMI event filtering application 115. If embodied in software, each block may represent a module, segment, or portion of code that comprises program instructions to implement the specified logical function(s). The program instructions may be embodied in the form of source code that comprises human-readable statements written in a programming language or machine code that comprises numerical instructions recognizable by a suitable execution system such as a processor 403 in a computer system or other system. The machine code may be converted from the source code, etc. If embodied in hardware, each block may represent a circuit or a number of interconnected circuits to implement the specified logical function(s).

Although the flowchart of FIG. 3 shows a specific order of execution, it is understood that the order of execution may differ from that which is depicted. For example, the order of execution of two or more blocks may be scrambled relative to the order shown. Also, two or more blocks shown in succession in FIG. 3 may be executed concurrently or with partial concurrence. Further, in some embodiments, one or more of the blocks shown in FIG. 3 may be skipped or omitted. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

Also, any logic or application described herein, including the AMI event filtering application 115, that comprises software or code can be embodied in any non-transitory computer-readable medium for use by or in connection with an instruction execution system such as, for example, a processor 403 in a computer system or other system. In this sense, the logic may comprise, for example, statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system. The computer-readable medium can comprise any one of many physical media such as, for example, magnetic, optical, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium may be a random access memory (RAM) including, for example, static random access memory (SRAM) and dynamic random access memory (DRAM), or magnetic random access memory (MRAM). In addition, the computer-readable medium may be a read-only memory (ROM), a programmable read-only memory (PROM), an erasable programmable read-only memory (EPROM), an electrically erasable programmable read-only memory (EEPROM), or other type of memory device.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

Therefore, the following is claimed:

1. A method, comprising the steps of:
receiving at least one event from an AMI head-end, the at least one event associated with a utility metering device;
validating the at least one event from the AMI head-end;
generating at least one validated event corresponding to the at least one event;
publishing the at least one validated event on an enterprise service bus, the enterprise service bus configured to transmit the at least one event to the AMI database for storage in the AMI database;
generating at least one of a destination filtered event based at least upon a destination filter and a composite event based at least upon a composite event definition; and
publishing the at least one of the destination filtered event and the composite event published on the enterprise service bus.

2. The method of claim 1, wherein the at least one event is associated with at least one of a communications tower and a distribution substation.

3. The method of claim 1, further comprising the step of transmitting at least one of: the at least one validated event, the composite event, and the destination filtered event, to a subscribing system configured to communicate with the enterprise service bus.

4. The method of claim 3, further comprising the step of generating a configuration user interface facilitating configuration of a subscription of the at least one subscribing system.

5. The method of claim 3, further comprising the steps of:
retrieving at least one destination filter associated with a subscribing system;
determining whether the at least one validated event complies with the at least one destination filter;
generating a destination filtered event, the destination filtered event having a destination designation corresponding to the subscribing system; and
publishing the destination filtered event on the enterprise service bus.

6. The method of claim 3, further comprising the steps of:
retrieving a composite event definition, the composite event definition defining a plurality of events comprising a composite event;
determining whether the at least one validated event corresponds to an event specified by the composite event definition;
querying the AMI database for at least one second event specified by the composite event definition;
generating the composite event when the at least one second event and the at least one validated event correspond to events specified by the composite event definition; and
publishing the composite event on the enterprise service bus.

7. The method of claim 1, further comprising the step of translating the at least one event into a storage format compatible with at least one table from the AMI database.

8. The method of claim 1, further comprising the steps of:
identifying an identifier in the at least one validated event uniquely identifying the utility metering device; and
retrieving at least one attribute regarding the utility metering device based at least upon the identifier.

9. The method of claim 8, wherein the step of retrieving the at least one attribute regarding the utility metering device further comprises the step of retrieving at least one of: an operating company, customer account data, a geographic location, and a maintenance status.

10. The method of claim 1, further comprising the steps of:
determining whether an event message format of the at least one event corresponds to a message format compatible with at least one of: an AMI head-end type, a communications tower type and a utility metering device type in an AMI deployment; and
discarding the at least one event when the event message format is incompatible with the AMI head-end type, the communications tower type and the utility metering device type in the AMI deployment.

11. The method of claim 1, further comprising the steps of:
determining whether the at least one event is a duplicate event; and
discarding the duplicate event.

12. A system, comprising:
at least one computing device;
an advanced metering infrastructure (AMI) event filtering application executable in the AMI database, the AMI event filtering application comprising:
logic that receives at least one event from an AMI head-end, the at least one event associated with at least one communications tower and a utility metering device;
logic that validates the at least one event from the AMI head-end;
logic that publishes the at least one event on an enterprise service bus executed in the at least one computing device, the enterprise service bus is configured to transmit the at least one event to the AMI database for storage in the AMI database; and
logic that generates at least one of a destination filtered event and a composite event, the at least one of the destination filtered event and the composite event published on the enterprise service bus.

13. The system of claim 12, further comprising at least one subscribing system in communication with the at least one computing device, the at least one subscribing system configured to subscribe to at least one of: the at least one event, the composite event, and the destination filtered event, the subscribing system configured to communicate with the enterprise service bus.

14. The system of claim 13, further comprising a configuration server executed in the at least one computing device, the configuration server generating a configuration user interface facilitating configuration of a subscription of the at least one subscribing system.

15. The system of claim 13, wherein the logic that generates a destination filtered event further comprises:
logic that retrieves the subscription associated with a subscribing system, the subscription defining at least one destination filter;
logic that determines whether the at least one event complies with the at least one destination filter;
logic that adds a generates a destination designation to the at least one event, the destination designation corresponding to the subscribing system; and
logic that publishes the at least one event and the destination designation on the enterprise service bus.

16. The system of claim 13, wherein the logic that generates a composite event further comprises:
logic that retrieves a composite event definition, the composite event defining a plurality of events comprising a composite event;
logic that determines whether the at least one event corresponds to an event specified by the composite event definition;
logic that queries the AMI database for at least one second event specified by the composite event definition;
logic that generates the composite event when the second event and the at least one event and the at least one second correspond to events specified by the composite event definition; and
logic that publishes the composite event on the enterprise service bus.

17. The system of claim 12, wherein the AMI event filtering application further comprises logic that translates the at least one event into a storage format compatible with at least one table from the AMI database.

18. The system of claim 12, wherein the AMI event filtering application further comprises:
logic that identifies an identifier in the at least one event uniquely identifying the at least one of the communications tower and the utility metering device; and
logic that retrieves at least one attribute regarding the at least one of the communications tower and the utility metering device based at least upon the identifier.

19. The system of claim 18, wherein the logic that retrieves the at least one attribute regarding the at least one of the communications tower and the utility metering device further comprises:
logic that retrieves at least one of a (operating company, customer data, etc.)

20. The system of claim 12, wherein the logic that validates the at least one event further comprises:
logic that determines whether an event message format of the at least one event corresponds to a message format compatible with at least one of: an AMI head-end type, a communications tower type and a utility metering device type in an AMI deployment; and
logic that discards the at least one event when the event message format is incompatible with the AMI head-end type, the communications tower type and the utility metering device type in the AMI deployment.

21. The system of claim 12, wherein the logic that validates the at least one event further comprises:
logic that determines whether the at least one event is a duplicate event; and
logic that discards the duplicate event.
